(19) United States
(12) Patent Application Publication
(10) Pub. No.: US 2025/0246637 A1
(43) Pub. Date: Jul. 31, 2025

(54) ANODE CURRENT COLLECTOR, ANODE, AND LITHIUM-METAL SECONDARY BATTERY

(71) Applicant: TOYOTA JIDOSHA KABUSHIKI KAISHA, Toyota-shi (JP)

(72) Inventor: Hiroyuki YAMAGUCHI, Toyota-shi (JP)

(73) Assignee: TOYOTA JIDOSHA KABUSHIKI KAISHA, Toyota-shi (JP)

(21) Appl. No.: 18/904,767

(22) Filed: Oct. 2, 2024

(30) Foreign Application Priority Data
Jan. 26, 2024 (JP) 2024-010031

(51) Int. Cl. H01M 4/66; H01M 4/02; H01M 4/80; H01M 10/052

(52) U.S. Cl. CPC H01M 4/668; H01M 4/806; H01M 10/052; H01M 2004/027

(57) ABSTRACT

An anode current collector includes a resin and a fibrous conductive filler, in which an aspect ratio of the fibrous conductive filler is 20 or more, a content of the resin in the anode current collector is 60% by mass or more and less than 90% by mass, and a content of the fibrous conductive filler in the anode current collector is more than 10% by mass and 40% by mass or less.

### CROSS-REFERENCE TO RELATED APPLICATION

This application claims priority to Japanese Patent Application No. 2024-010031 filed on Jan. 26, 2024, incorporated herein by reference in its entirety.

### BACKGROUND

### 1. Technical Field

The present disclosure relates to an anode current collector, an anode, and a lithium-metal secondary battery.

### 2. Description of Related Art

Japanese Unexamined Patent Application Publication No. 2019-21384 discloses a battery including a current collector layer containing a conductive filler and a resin, an electrode layer, and a displacement absorbing portion that is located between the current collector layer and the electrode layer and that includes an elastic body made of metal or metal fiber.

### SUMMARY

Conventionally, metal foil is used as an electrode current collector. Reduction in amount of metal is being demanded from the perspectives of, for example, reduction in material costs, mass energy density, and so forth. For example, as an alternative to metal foil, a resin current collector containing conductive filler and resin has been proposed.

Also, lithium-metal secondary batteries are being studied. Lithium-metal secondary batteries have higher energy density than conventional lithium-ion secondary batteries. Anode reactions in the lithium-metal secondary battery are dissolution reaction of lithium and deposition reaction thereof. During charging, lithium ions receive electrons on the surface of the anode current collector, and thus lithium is deposited.

On the other hand, when a resin current collector is used as an anode current collector of a lithium-metal secondary battery, conductive filler may become dislodged. As a result, cycling characteristics may deteriorate.

An object of the present disclosure is to improve cycling characteristics.
[1] In an anode current collector that contains a resin and a fibrous conductive filler,
   an aspect ratio of the fibrous conductive filler is no less than 20.
   Content of the resin in the anode current collector is no less than 60% by mass and less than 90% by mass.
   Content of the fibrous conductive filler in the anode current collector is more than 10% by mass and no more than 40% by mass.

By using the fibrous conductive filler having a predetermined aspect ratio, even when lithium is deposited from the anode current collector during charging, the fibrous conductive filler is suppressed from being dislodged, and accordingly improved cycling characteristics are anticipated. Also, due to including resin and fibrous conductive filler at a predetermined ratio, moldability is excellent, and suppressed increase in resistance is also anticipated.
[2] The anode current collector according to [1], wherein the fibrous conductive filler is fibrous carbon.
[3] The anode current collector according to [1] or [2], wherein the resin is a polyolefin-based resin.
[4] An anode, including the anode current collector according to any one of [1] to [3].
[5] A lithium-metal secondary battery, including the anode according to [4].

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of an anode current collector according to the present embodiment;

FIG. 2 is a schematic diagram illustrating an example of an anode of the present embodiment;

FIG. 3 is a schematic diagram showing an example of the lithium-metal secondary battery of the present embodiment;

FIG. 4 is a graph showing the volume retention ratio of the lithium-metal secondary batteries in Examples and Comparative Examples with respect to the number of cycles of the lithium-metal secondary batteries; and

FIG. 5 is a table showing the configuration and evaluation results of the anode current collector in Examples and Comparative Examples.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

As used herein, the term “lithium-metal secondary battery” refers to a battery in which the anode reaction includes a dissolution and precipitation reaction of lithium metal. For example, the dissolution and precipitation reaction of the lithium metal may account for 1-100%, 25-100%, 50-100%, or 75-100% of the anode capacity. The anode capacitance represents a reversible capacitance. For example, in SOC of 1 to 100%, 1 to 75%, 1 to 50%, or 1 to 25%, there may be a lithium-metal deposition on the anode. At a SOC of 0% (fully discharged), the lithium-metal may dissolve in the electrolyte in total. At a SOC of 0%, a portion of the lithium-metal may remain in the anode.

In the present specification, the lithium-metal secondary battery may be, for example, a liquid-based battery or an all-solid-state battery. The lithium-metal secondary battery may be, for example, a monopolar battery (unipolar battery) or a bipolar battery. Anode current collector

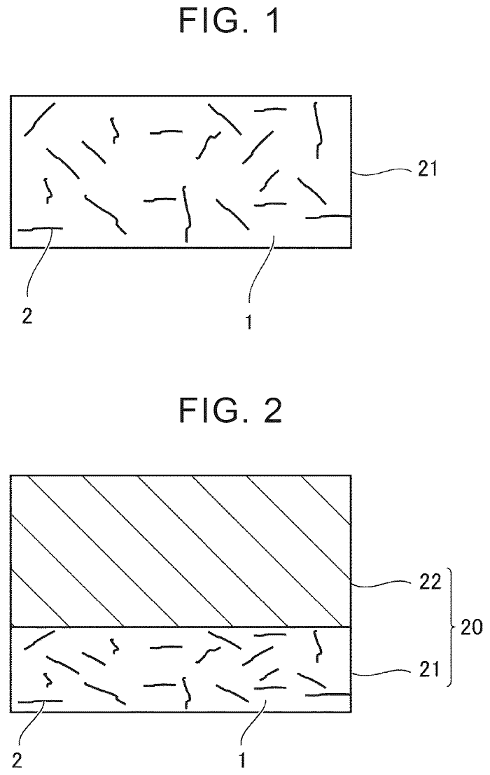

FIG. 1 is a schematic diagram illustrating an example of an anode current collector according to the present embodiment. The anode current collector 21 includes a resin 1 and a fibrous conductive filler 2. The aspect ratio of the fibrous conductive filler 2 is 20 or more. The content of the resin 1 in the anode current collector 21 is 60% by mass or more and less than 90% by mass, and the content of the fibrous conductive filler 2 in the anode current collector 21 is more than 10% by mass and not more than 40% by mass. The anode current collector 21 is a resin current collector for a lithium-metal secondary battery.

### Resin

Resin 1 may include, for example, polyolefin-based resins, urethane-based resins, polyamide-based resins, cellulose-based resins, polyether-based resins, acrylic-based resins, and at least one type selected from the group consisting of polyester-based resins and the like. The resin 1 may include, for example, at least one selected from the group consisting of polyethylene (PE), polypropylene (PP), polyethylene terephthalate (PET), polyvinylidene fluoride (PVdF), polytetrafluoroethylene (PTFE), polyamide (PA), polyamideimide (PAI), polyimide (PI), aromatic polyamide (aramid), nylon, liquid crystal polyester, polyacrylate, polymethacrylate, polystyrene, AS resin, ABS resin, polyphenylene ether (PPE), and silicone resin. Resin 1 is preferably PE and PP. The resin 1 may be used singly or in a mixture of two or more thereof.

The content of the resin 1 in the anode current collector 21 is 60% by mass or more and less than 90% by mass. When the content of the resin 1 in the anode current collector 21 is within the above range, the moldability is excellent, and an increase in resistance is also expected to be suppressed. The content of the resin 1 in the anode current collector 21 is preferably 70% by mass or more and 80% by mass or less.

### Fibrous Conductive Filler

The fibrous conductive filler 2 is made of a material having conductivity. Examples of the conductive material include carbon, metal, and metal plating. Examples of carbon include carbon black (CB), graphite, vapor-grown carbon fibers (VGCF), carbon nanotubes (CNT), carbon nanofibers, and carbon nanospheres. Examples of the metal include nickel (Ni), aluminum (Al), copper (Cu), silver (Ag), and stainless steel. Examples of the metal plating include nickel plating, aluminum plating, copper plating, and silver plating. The conductive material is preferably carbon, and more preferably VGCF and CNT. The fibrous conductive filler 2 may be used singly or in a mixture of two or more thereof.

The shape of the conductive filler is fibrous. Conventionally, the shape of a conductive filler used in a resin current collector is generally particulate. On the other hand, when lithium (Li) is precipitated at the time of charge, the particulate conductive filler tends to fall off from the resin due to the stress. Therefore, the present inventors have used a fibrous conductive filler instead of a particulate conductive filler. By using the fibrous conductive filler, even when Li is precipitated at the time of charge, the fibrous conductive filler is suppressed from falling off from the resin.

The aspect ratio of the fibrous conductive filler 2 is 20 or more. When the aspect ratio of the fibrous conductive filler 2 is 20 or more, improvement in cycle characteristics is more expected. The aspect ratio of the fibrous conductive filler 2 may be 25 or more and may be 30 or more. The aspect ratio of the fibrous conductive filler 2 may be 50 or less and may be 40 or less.

Aspect ratio is the ratio of length to diameter. The “aspect ratio” in the present embodiment is obtained by dividing the average length of the fibrous conductive filler 2 by the average diameter of the fibrous conductive filler 2. The average length and the average diameter may each be an arithmetic average of the measurements in 10 or more fibrous conductive fillers 2. The length and diameter of the individual fibrous conductive fillers 2 can be measured by Scanning Electron Microscope(SEM) or Scanning Probe Microscope (SPM).

The fibrous conductive fillers 2 may have, for example, a mean diameter of 50 nm or more and 200 nm or less. The fibrous conductive filler 2 may have an average length of, for example, 1 μm or more and 10 μm or less.

The content of the fibrous conductive filler 2 in the anode current collector 21 is more than 10% by mass and not more than 40% by mass. When the content of the fibrous conductive filler 2 in the anode current collector 21 is 10 mass % or less, there is a possibility that the conductivity becomes insufficient. When the content of the fibrous conductive filler 2 in the anode current collector 21 is more than 40% by mass, there is a possibility that, even if the anode current collector cannot be molded or can be molded, the fibrous conductive filler 2 may aggregate to generate voids. The content of the fibrous conductive filler 2 in the anode current collector 21 is preferably 20% by mass or more and 30% by mass or less.

The anode current collector 21 may be substantially composed of the resin 1 and the fibrous conductive filler 2, or may be composed of the resin 1 and the fibrous conductive filler 2. Note that “substantially composed of the resin 1 and the fibrous conductive filler 2” means that the content of the resin 1 and the fibrous conductive filler 2 in the anode current collector 21 is 95 mass % or more.

### Other Ingredients

The anode current collector 21 may contain a conductive filler, a dispersant, or the like other than the fibrous conductive filler 2. Examples of the conductive filler other than the fibrous conductive filler 2 include carbon particles, metal particles, and metal plated particles. Examples of the dispersant include surfactants. The content of the other components in the anode current collector 21 is, for example, 0.1 mass % or more and 5 mass % or less.

### Method for Manufacturing Anode Current Collector

The anode current collector can be manufactured by the following method. However, the following manufacturing method is an example, and the present disclosure is not limited thereto.

A resin composition is formed by mixing a resin, a fibrous conductive filler, and, if necessary, other components. The resin composition may also be referred to as a “compound” or the like, for example. The resin composition may be in the form of pellets, for example. The resin composition may be formed by any method. For example, melt-kneading may be performed. For example, melt-kneading may be performed by a twin-screw extruder.

The anode current collector is formed by molding the resin composition by an arbitrary method. The molding method is not particularly limited, and examples thereof include known methods such as a T-die method, an inflation method, and a calendering method.

### Anode

FIG. 2 is a schematic diagram illustrating an example of the anode of the present embodiment. The anode 20 includes an anode current collector 21 and a lithium metal layer 22. The anode current collector 21 is as described above.

### Lithium Metal Layer

The lithium metal layer 22 includes a lithium metal. The lithium metal layer 22 is a layer formed by depositing lithium metal deposited on the anode 20. As SOC increases or decreases, the thickness of the lithium-metal layers varies.

### Lithium-Metal Secondary Battery

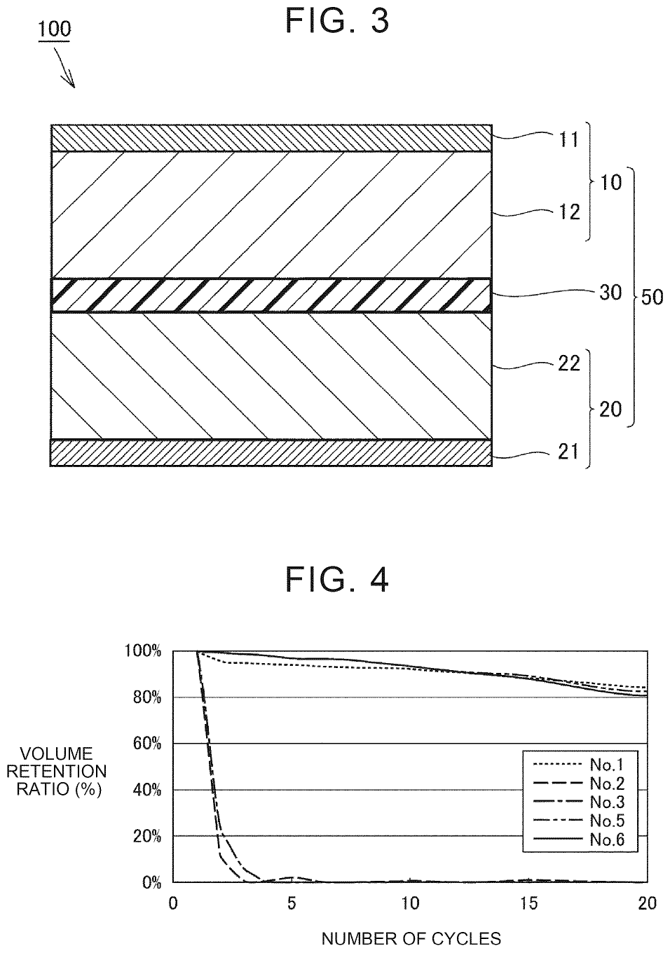

FIG. 3 is a schematic diagram illustrating an example of a lithium-metal secondary battery (hereinafter, also simply referred to as a “battery”) according to the present embodiment. Hereinafter, a liquid-based monopolar battery will be described as an example, but the present disclosure is not limited thereto.

The battery 100 may include an exterior body (not shown). The exterior body may house the power generation element 50 and an electrolyte (not shown). The sheath may have any form. The exterior body may be, for example, a metal case or a pouch made of a metal foil laminate film. The outer casing may include, for example, a Al or the like.

The battery 100 includes a power generation element 50. The power generation element 50 may also be referred to as an electrode body or an electrode group. The power generation element 50 includes a positive electrode 10, a separator 30, and an anode 20. The power generation element 50 has any structure. For example, the power generation element 50 may be wound. Each of the positive electrode 10, the separator 30, and the anode 20 may be a belt-shaped sheet. The power generation element 50 may be formed by, for example, laminating the positive electrode 10, the separator 30 (first sheet), the anode 20, and the separator 30 (second sheet) in this order. After winding, the power generation element 50 may be formed into a flat shape.

### Positive Electrode

The positive electrode 10 may include a positive electrode current collector 11 and a positive electrode active material layer 12. The positive electrode current collector 11 may include, for example, an aluminium (Al) foil. The positive electrode active material layer 12 includes a positive electrode active material. The positive electrode active material layer 12 may further include, for example, a conductive material, a binder, and the like.

The positive electrode active material may be in a particulate form, for example. The positive electrode active material may have a D50 of, for example, 1 to 30 micrometers. The positive electrode active material may include, for example, at least one selected from the group consisting of LiCoO₂, LiNiO₂, LiMnO₂, Li(NiCoMn)O₂, and Li(NiCoAl)O₂. For example, “(NiCoMn)” in “Li(NiCoMn)O₂” indicates that the sum of the compositional ratios in parentheses is 1. As long as the sum is 1, the amounts of the individual components are optional.

The conductive material may include, for example, acetylene black (AB). The binder may include, for example, PVdF or the like. The conductive material and the binder may be, for example, 0.1 mass % or more and 10 mass % or less with respect to the positive electrode active material layer 12.

### Separator

The separator 30 is porous. The separator 30 may pass through the electrolytic solution. The separator 30 separates the positive electrode 10 and the anode 20 from each other. The separator 30 is electrically insulating. The separator 30 may include, for example, a polyolefin-based resin such as polyethylene (PE) or polypropylene (PP). The separator 30 may have, for example, a single-layer structure or a multi-layer structure. The separators 30 may consist of, for example, substantially PE layers, and may be formed by laminating PP layers, PE layers, and PP layers in this order.

### Electrolytic Solution

The electrolyte solution includes solvents and Li salts. The solvent is aprotic. The solvent may comprise any component. The solvents may include, for example, at least one selected from the group consisting of ethylene carbonate (EC), dimethyl carbonate (DMC), and ethyl methyl carbonate (EMC).

Li salt is a supporting electrolyte. Li salt is dissolved in a solvent. Li salt may include, for example, at least one selected from the group consisting of LiPF₆ and LiBF₄. Li salt may have a molar concentration of, for example, 0.5 mol/L or more and 2.0 mol/L or less.

The electrolyte solution may further contain an optional additive. The electrolytic solution may contain, for example, 0.01% by mass or more and 5% by mass or less of an additive. The additive may include, for example, at least one selected from the group consisting of vinylene carbonate (VC), vinyl ethylene carbonate (VEC), and the like.

### No. 1

A Cu foil (thickness: 10 micrometers) was prepared as a material of the anode current collector. Cu foil was used as the anode.

As a material of the positive electrode, a layered LiNi_{1/3}Co_{1/3}Mn_{1/3}O₂ (mean particle diameter: 10 μm) (90% by mass), a AB (8% by mass) as a conductive material, and a PVdF (2% by mass) as a binder were prepared. These materials were mixed with N-methyl-2-pyrrolidone (NMP) as a solvent so that the solid content was 56 wt %, and mixed using a planetary mixer to obtain a positive electrode slurry.

The obtained positive electrode slurry was applied to Al foil, which was a positive electrode current collector, using a die coater. After the coating, the positive electrode slurry was dried at 120° C. and compressed by a roll press to obtain a positive electrode.

As separators, porous resins (PP/PE/PP) in which PP layers were laminated on both sides of PE layers were prepared. The positive electrode, the separator, and the anode were laminated in this order to form a power generation element.

As an exterior body, a pouch made of a laminate film was prepared. The power generation element was housed in the outer casing. As the electrolyte solution, a mixed solvent containing EC and DMC in a volume ratio of 1:1 was prepared by dissolving a support salt (LiPF₆) at a 1.0mol/L level. The electrolyte solution was injected into the exterior body. After injection of the electrolyte, the outer casing was sealed. From the above, the test battery was assembled.

At 25° C., the test cell was charged in a constant current manner with a current of 0.4mA/cm² until the positive electrode potential reached 4.3V. Subsequently, the test cell was discharged in a constant current manner by a current of 0.4mA/cm² until the positive electrode potential reached 3.0V. Thus, a lithium metal layer was formed on the surface of the anode current collector. Thus, a No.1 test cell was manufactured. No.1 test battery is a reference battery using the same metallic foil (Cu foil) as the conventional anode current collector.

### No. 2

A PE (Novatech HDHF560, manufactured by Nippon Polyethylene Co., Ltd.) as resin and a CB made of an aggregate of particulate carbon as conductive fillers were prepared as the anode current collector.

A compound was formed by weighing PE and CB in a weight ratio of 80:20 and melt-kneading by a twin-screw extruder. The compound was extruded by a T-die method to obtain a No.2 anode current collector (thickness: 50 micrometers).

No.2 test cells were fabricated using the same materials and methods as No.1, except that No.2 anode current collectors were used as the anode.

### No. 3

As a material of the anode current collector, the same PE resin as that of No.2 and particulate Ni as conductive fillers were prepared. A compound was formed by weighing PE and Ni in a weight ratio of 95:5 and melt-kneading by a twin-screw extruder. The compound was extruded by a T-die method to obtain a No.3 anode current collector (thickness: 50 micrometers).

No.3 test cells were fabricated using the same materials and methods as No.1, except that No.3 anode current collectors were used as the anode.

### No. 4 to 6

As a material of the anode current collector, the same PE as that of No.2 was prepared as a resin, and VGCF (manufactured by Resonak Co., Ltd., VGCF-H) (aspect-ratio: 26.7) was prepared as a fibrous conductive filler. PE and VGCF were weighed so as to have a predetermined weight ratio, and melt-kneaded by a twin-screw extruder to form a compound. The compound was extruded by a T-die process to obtain an anode current collector (thickness: 50 micrometers) of No.4 to 6. In No.4, PE and VGCF were weighed so that the weight ratio was 90:10. In No.5, PE and VGCF were weighed in a weight ratio of 80:20. In No.6, PE and VGCF were weighed in a weight ratio of 70:30.

Test cells from No.4 to 6 were fabricated using the same materials and methods as No.1, except that negative current collectors from No.4 to 6 were used as the anodes.

### Evaluation

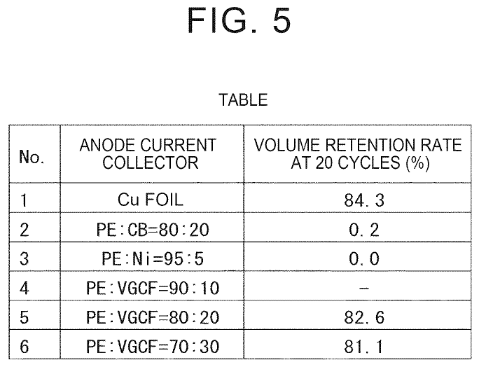

At 25° C., a current of 1.0mA/cm² charged the test cells of the respective No. in a constant current manner until the positive electrode potential reached 4.3V. Subsequently, the test cell was discharged in a constant current manner by a current of 1.0mA/cm² until the positive electrode potential reached 3.0V. A cycle test in which the cycle was one cycle was performed for 20 cycles. The discharge capacity retention ratio was obtained by dividing the discharge capacity at each cycle by the discharge capacity at the first cycle. The results are shown in FIG. 4. Further, a numerical value of the discharge capacity retention rate at the 20th cycle is shown in FIG. 5. It should be noted that No.4 cannot be charged and discharged, and the battery does not operate, so that the discharge capacity retention rate cannot be determined.

### Results

As shown in FIGS. 4 and 5, it can be seen that in No.5 and 6, the capacity retention ratio is higher than that in No.2 and 3. In addition, in No.5 and 6, it can be seen that the capacity retention ratio is the same as that of No.1, which is a reference cell.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. An anode current collector that contains a resin and a fibrous conductive filler, wherein
an aspect ratio of the fibrous conductive filler is no less than 20,
content of the resin in the anode current collector is no less than 60% by mass and less than 90% by mass, and
content of the fibrous conductive filler in the anode current collector is more than 10% by mass and no more than 40% by mass.

2. The anode current collector according to claim 1, wherein the fibrous conductive filler is fibrous carbon.

3. The anode current collector according to claim 1, wherein the resin is a polyolefin-based resin.

4. An anode, comprising the anode current collector according to claim 1.

5. A lithium-metal secondary battery, comprising the anode according to claim 4.
